(19) United States
(12) Patent Application Publication
(10) Pub. No.: US 2012/0162974 A1
(43) Pub. Date: Jun. 28, 2012

(54) LED LAMP

(75) Inventors: GUANG YU, Shenzhen City (CN); QIAN XIANG, Shenzhen City (CN)

(73) Assignees: FOXCONN TECHNOLOGY CO., LTD., New Taipei (TW); FU ZHUN PRECISION INDUSTRY (SHEN ZHEN) CO., LTD., Shenzhen City (CN)

(21) Appl. No.: 13/004,038

(22) Filed: Jan. 11, 2011

(30) Foreign Application Priority Data
Dec. 27, 2010 (CN) 201010607327.7

(51) Int. Cl. F21V 29/00

(52) U.S. Cl. 362/218

(57) ABSTRACT

An LED lamp includes a heat sink and an LED module. The heat sink includes a heat plate, first lateral walls, and second lateral walls. The heat plate has a first surface and a second surface opposite to the first surface. The first lateral walls extend from the two sides of the first surface. The second lateral walls extend from the two sides of the second surface along a direction opposite to that of the first lateral walls. A plurality of fins extends from outer surfaces of the second lateral walls and the second surface of the heat plate. The LED module is arranged on the first surface of the heat plate and located between the first lateral walls.

### BACKGROUND

1. Technical Field

The present disclosure relates to an LED lamp, and particularly to an LED lamp having a heat dissipation apparatus for heat dissipation.

2. Discussion of Related Art

The technology of light emitting diode (LED) has been rapidly developed in recent years from indicators to illumination applications. With the features of long-term reliability, environment friendliness and low power consumption, the LED is viewed as a promising alternative for future lighting products. Nevertheless, the rate of heat generation increases with the illumination intensity. For a high-power LED illumination device, heat accumulation can affect the life, stability and reliability of the device. The issue, i.e., how to effectively dissipate the heat of the LED illumination device has become a challenge for engineers to design the LED illumination, i.e. the LED lamp.

What is needed, therefore, is an LED lamp which has greater heat-transfer and heat dissipation capabilities, whereby the LED lamp can operate normally for a sufficiently long period of time.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled view of an LED lamp in accordance with an embodiment of the present disclosure.

FIG. 2 is an exploded, isometric view of the LED lamp of FIG. 1.

FIG. 3 is an enlarged view of III of FIG. 2.

FIG. 4 is a cross-sectional view of the LED lamp of FIG. 1.

### DETAILED DESCRIPTION OF EMBODIMENTS

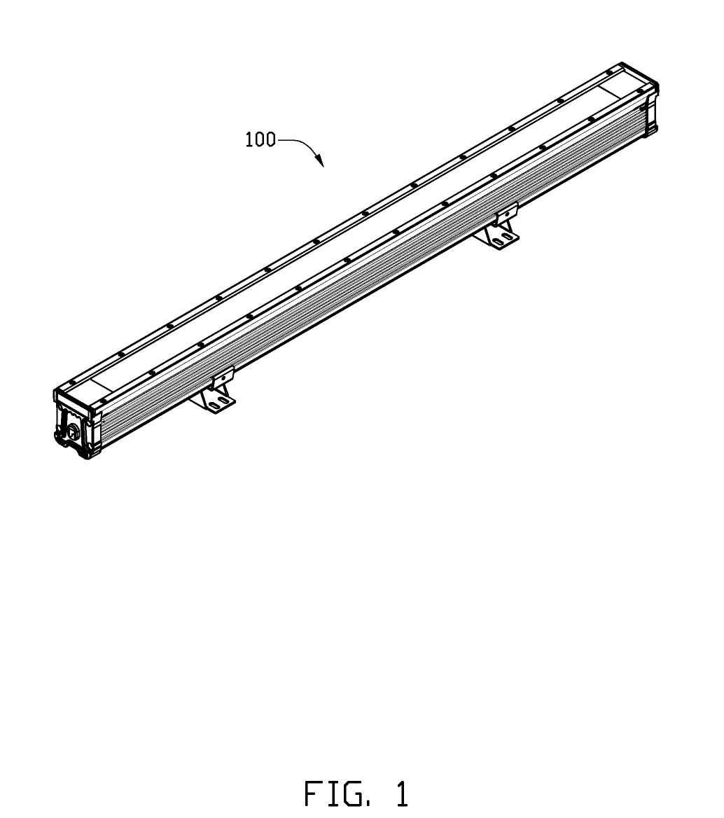

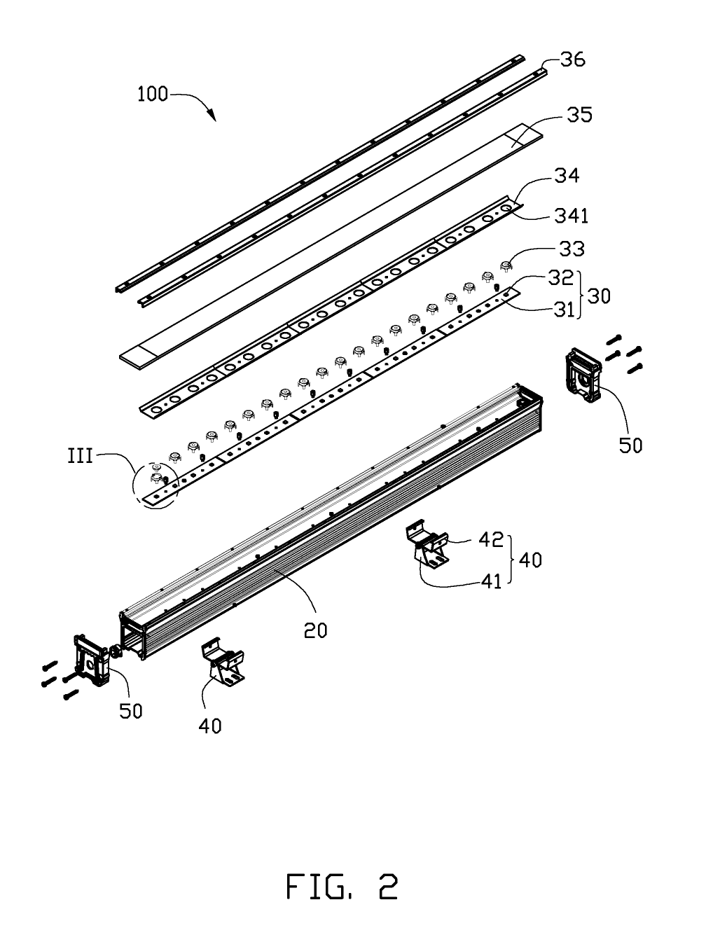

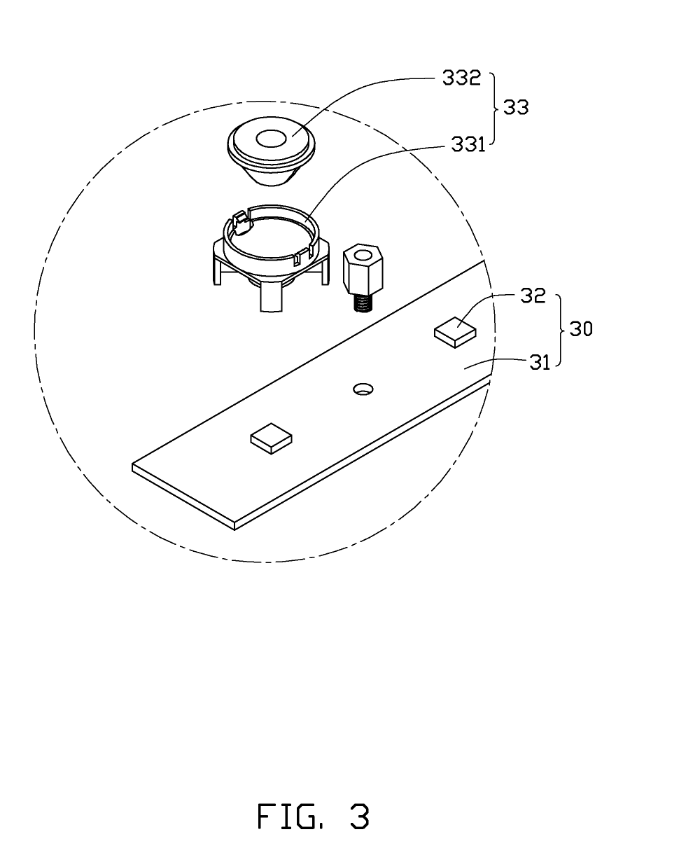

Referring to the FIGS. 1-3, an LED lamp 100, in accordance with an embodiment is shown. The LED lamp 100 includes a heat sink 20 and an LED module 30.

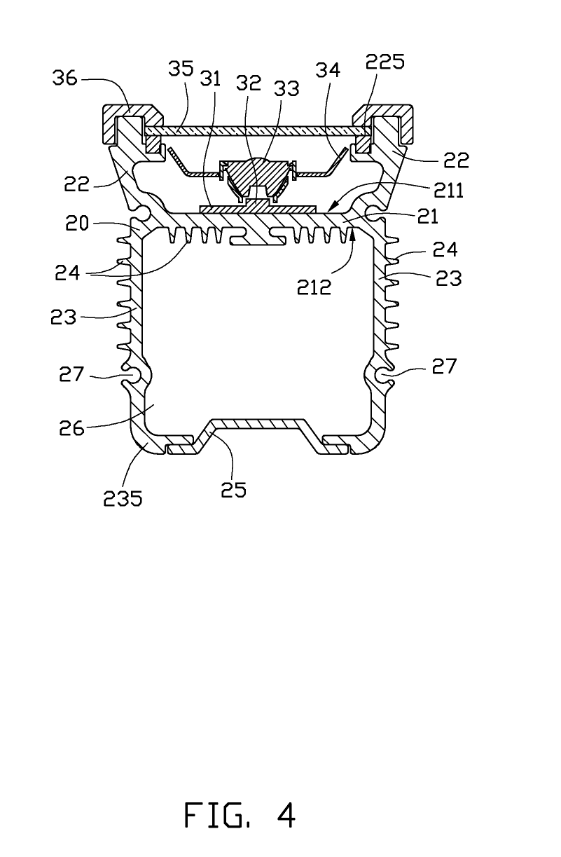

Referring to the FIG. 4, the heat sink 20 includes a heat plate 21 having a first surface 211 and a second surface 212 opposite to the first surface 211, two first lateral walls 22 extending upwardly and outwardly from two sides of the first surface 211 of the heat plate 21, respectively, two second lateral walls 23 extending downwardly from two sides of the second surface 212 of the heat plate 21, respectively, and a plurality of fins 24 extending from the second surface 212 of the heat plate 21 and outside surfaces of the second lateral walls 23. In the present embodiment, the heat sink 20 is formed by aluminum extrusion to have an elongated configuration.

The first lateral walls 22 extend upwardly from the two sides of the first surface 211 of the heat plate 21, and are slant relative to the heat plate 21. The cross section of the heat plate 21 with the first lateral walls 22 is generally U-shaped. A top portion of each of the first lateral walls 22 at an inner side thereof has a supporting portion 225.

The second lateral walls 23 extend downwardly from two sides of a second surface 212 of the heat plate 21. In the present embodiment, the second lateral walls 23 are perpendicular to the heat plate 21. A free end of the second lateral wall 23 flexes inwardly to define a fixing portion 235. In the present embodiment, the heat sink 20 further includes a substrate 25. The substrate 25 and the fixing portion 235 are securely engaged with each other via a plurality of screws (not shown); therefore, the second lateral walls 23, the heat plate 21 and the substrate 25 cooperatively define a hollow rectangular chamber 26. Each second side surface 23 defines an elongated recess 27 at a lower portion of an outside surface thereof. The recess 27 extends along an axial direction of the heat sink 20.

The fins 24 extend from the second surface 212 of the heat plate 21 and the outside surfaces of the second lateral walls 23. The fins 24 are elongated and spaced from each other. The fins 24 extending from the second lateral walls 23 are arranged between the heat plate 21 and the recesses 27.

The heat sink 20 can be integrally formed of a metal with good heat conductivity such as aluminum, copper or an alloy thereof. In this embodiment, the heat sink 20 is made of aluminum extrusion and is extruded along a lengthways direction from a first end (not labeled) to a second end (not labeled) thereof; thus, the heat sink 20 can be manufactured into different lengths by severing an extruded semi-finished product, without the necessity of redesigning a mould/die.

The LED module 30 includes an elongated printed circuit board 31, and a plurality of LEDs 32 mounted on the printed circuit board 31 and arrayed in a line. A plurality of lens modules 33 each are made of a transparent material, such as epoxy resin, polymethyl methacrylate (PMMA), and so on. The lens modules 33 have an amount equal to that of the LEDs 32. Each lens modules 33 covers a corresponding LED 32 to modulate the characteristics of light generated by the corresponding LED 32. Each lens module 33 includes a base 331 and a lens 332 protruding upwardly from the base 331. The lens 332 defines a cavity (not shown) at a bottom thereof for receiving a corresponding LED 32 therein. An outer, peripheral portion (not labeled) of a reflector 34 is concave to reflect light generated by the LEDs 32. A central area of the reflector 34 is plate-like and defines a plurality of openings 341. The reflector 34 abuts against the bases 331 of the lens module 33 with the lenses 332 extending through the openings 341 of the reflector 34, respectively. A transparent plate 35 is mounted on the supporting portions 225 of the first lateral walls 22. Two fixing strips 36 are mounted on tops of the first lateral walls 22 of the heat sink 20 and press the transparent plate 35 downwardly.

The LED lamp 100 further includes two mounting brackets 40. Each of the mounting brackets 40 includes a first fixing member 41 and a second fixing member 42 pivotally engaged with the first fixing member 41. The second fixing member 42 is engaged in the recesses 27 of the second lateral walls 23 to support the LED lamp 100. The LED lamp 100 can be adjusted to rotate relative to the mounting brackets 40. In other embodiments, an amount of the mounting brackets 40 can be three, or any other number such as four, or more than four.

The LED lamp further includes two connectors 50. The connectors 50 are secured at the first and second ends of the heat sink 20 via a plurality of screws (not labeled). The connectors 50 are provided for connecting with an external power source whereby the LED lamp 100 can obtain the required electrical power for generating light.

It is to be further understood that even though numerous characteristics and advantages have been set forth in the foregoing description of embodiments, together with details of the structures and functions of the embodiments, the disclosure is illustrative only; and that changes may be made in detail, especially in matters of shape, size, and arrangement of parts within the principles of the disclosure to the full extent indicated by the broad general meaning of the terms in which the appended claims are expressed.

What is claimed is:

1. An LED lamp comprising:
a heat sink comprising a heat plate, first lateral walls, and second lateral walls, the heat plate having a first surface and a second surface opposite to the first surface, the first lateral walls extending from two sides of the first surface, the second lateral walls extending from two sides of the second surface along a direction opposite to an extending direction of the first lateral walls, a plurality of fins extending from outer surfaces of the second lateral walls and the second surface of the heat plate; and
an LED module being arranged on the first surface of the heat plate and located between the first lateral walls.

2. The LED lamp of claim 1, wherein the fins are elongated and spaced from each other.

3. The LED lamp of claim 1, wherein the heat plate, the first lateral walls, and the second lateral walls of the heat sink are integrally formed as a single piece.

4. The LED lamp of claim 1, wherein a free end of each of the second lateral walls flexes inwardly to define a fixing portion, the heat sink further comprising a substrate, the substrate being engaged with the fixing portions of the second lateral walls.

5. The LED lamp of claim 4, wherein the heat plate, the second lateral walls, and the substrate cooperatively define a hollow rectangular chamber.

6. The LED lamp of claim 1, wherein the second lateral walls are perpendicular to the heat plate.

7. The LED lamp of claim 1, wherein the first lateral walls are slant relative to the heat plate.

8. The LED lamp of claim 1, wherein each of the outer surfaces of the second lateral walls defines an elongated recess, the LED lamp further comprising at least two mounting brackets engaged with the recesses.

9. The LED lamp of claim 8, wherein the fins extending from the second lateral walls are arranged between the heat plate and the recesses.

10. The LED lamp of claim 1, wherein the LED module comprising an elongated printed circuit board, a plurality of LEDs mounted on the printed circuit board, and a transparent plate arranged over the LEDs.

11. The LED lamp of claim 10, wherein a top portion of each of the first lateral walls has a supporting portion, the transparent plate being located at the supporting portions of the first lateral walls.

12. The LED lamp of claim 10, further comprising fixing strips, the fixing strips being mounted on tops of the first lateral walls and pressing the transparent plate downwardly.

13. An LED lamp comprising:
a heat sink comprising a heat plate, first lateral walls, and second lateral walls, the heat plate having a first surface and a second surface opposite to the first surface, the first lateral walls extending from two sides of the first surface, the second lateral walls extending from two sides of the second surface; and
an LED module being arranged on the first surface of the heat plate and located between the first lateral walls.

14. The LED lamp of claim 13, wherein the heat sink further comprises a plurality of fins extending from outer surfaces of the second lateral walls and the second surface of the heat plate.

15. The LED lamp of claim 14, wherein the fins are elongated and spaced from each other.

16. The LED lamp of claim 13, wherein a free end of each of the second lateral walls flexes inwardly to define a fixing portion, the heat sink further comprising a substrate, the substrate being engaged with the fixing portions of the second lateral walls.

17. The LED lamp of claim 16, wherein the heat plate, the second lateral walls, and the substrate cooperatively define a hollow rectangular chamber.
